(19) United States
(12) Patent Application Publication
(10) Pub. No.: US 2002/0125669 A1
(43) Pub. Date: Sep. 12, 2002

(54) Wheel base structure of dolly base wheel bag

(76) Inventor: Nia You Chang, Los Angeles, CA (US)

Correspondence Address: RAYMOND Y. CHAN, 108 N. YNEZ AVENUE,, SUITE 128, MONTERREY PARK, CA, 91754, US

(21) Appl. No.: 10/035,288

(22) Filed: Jan. 3, 2002

(51) Int. Cl. B62B 5/00

(52) U.S. Cl. 280/79.11; 280/47.34; 190/18 A

(57) ABSTRACT

A wheel base structure of dolly base wheel bag includes a bag body having a storage compartment, an interior surface, an exterior surface, a bottom sheet, a surrounding sheet, a longitudinal edge defined between the bottom sheet and the surrounding sheet, and at least two spaced apart through slots transversely provided at the longitudinal edge, a reinforcing panel having a L-shaped cross section, which is disposed in the storage compartment, mounted on the interior surface of the bag body, wherein the reinforcing panel has at least two parallel mounting slots aligning with the through slots of the bag body respectively, at least two wheel holders, each having a wheel cavity, substantially attached to the reinforcing panel through the mounting slots at the exterior surface of the bag body respectively, and at least a pair of wheels rotatably mounted in the wheel cavities of the wheel holders respectively.

### BACKGROUND OF THE PRESENT INVENTION

1. Field of Invention

The present invention relates to a carrying bag, and more particularly to a wheel base structure of a dolly base wheel bag wherein the wheel base structure is easily installed into any conventional bag while being cost effective. Moreover, the user is able to easily carry the bag in a stable manner.

2. Description of Related Arts

A heavy duty traveling bag is generally made of durable fabric material such as nylon or linen. Such traveling bag is in relative low cost and has an ability to rough handling such that most of the people like to use such traveling bag for transporting goods having a relative heavy weight or home moving. It is no doubt that the traveling bag is lightweight and durable. However, it is impossible for the user to carry the traveling bag everywhere.

An improved traveling bag is incorporated with a wheel arrangement which is facilitrated for the user to carry the traveling bag by rolling the traveling on the street. The traveling generally comprises a bag body 1A having a cavity and the wheel arrangement comprises a wooden board 1B received in the cavity of the bag body 1A and two pairs of wheels 1C mounted on a bottom surface of the bag body 1A and supported by the wooden board 1B, so as to enhance the portability of the traveling bag.

Normally, the traveling bag is 4 to 5 feet tall and is capable of carrying the goods having 200 bounds. In order to carry the traveling bag, the user usually applies a horizontal pulling force on top of the bag body 1A so as to pull the traveling bag everywhere. However, the traveling bag may easily be flipped over when the intentional pulling force is applied on the bag body, so as to cause an unwanted injury to other people around the traveling bag. In other words, the traveling bag fails to provide a stabilized portable feature. Especially while passing the Custom, the user may merely wait in line for inspection. However, the traveling bag fails to provide a “stop and go” feature for the user to quickly move and stop the traveling bag.

Beside, the wooden board 1B must be durable to support the heavy goods thereon so as to prevent the wooden board 1B from being broken by the downward force of the weight of the goods. The wooden board 1B will highly increase the overall weight of the traveling bag and thus increase the cost of the traveling bag. Therefore, such traveling bag will lose most of the ordinary features such as lightweight and heavy duty.

### SUMMARY OF THE PRESENT INVENTION

A main object of the present invention is to provide a wheel base structure of dolly base wheel bag wherein the wheel base structure is simple and easily installed into any conventional bag while being cost effective.

Another object of the present invention is to provide a wheel base structure of dolly base wheel bag, which can provide a “stop and go” feature that the user is able to easily and quickly control the movement of the bag.

Another object of the present invention is to provide a wheel base structure of dolly base wheel bag, the user is able to easily carry the bag by inclinedly pulling thereof in a stable manner, so as to prevent the bag from being flipped over accidentally.

Another object of the present invention is to provide a wheel base structure of dolly base wheel bag, wherein the wheel base structure does not require to change the original structural design of the bag, so as to minimize the manufacturing cost of the bag incorporating with the dolly base wheel.

Another object of the present invention is to provide a wheel base structure of dolly base wheel bag, wherein no expensive or complicate mechanical structure is required to employ in the present invention in order to achieve the above mentioned objects. Therefore, the present invention successfully provides an economic and efficient solution for providing reinforced dolly base wheel to carry the bag.

Accordingly, in order to accomplish the above objects, the present invention provides a wheel base structure of dolly base wheel bag, comprising:

a fabric made bag body having a storage compartment, an interior surface, an exterior surface, a bottom sheet, a surrounding sheet, a longitudinal edge defined between the bottom sheet and the surrounding sheet, and at least two spaced apart through slots transversely provided at the longitudinal edge;

a reinforcing panel having a L-shaped cross section, which is disposed in the storage compartment, mounted on the interior surface of the bag body, wherein the reinforcing panel has at least two parallel mounting slots aligning with the through slots of the bag body respectively;

at least two wheel holders, each having a wheel cavity, substantially attached to the reinforcing panel through the mounting slots at the exterior surface of the bag body respectively; and

at least a pair of edge wheels rotatably mounted in the wheel cavities of the wheel holders respectively.

### BRIEF DESCRIPTION OF THE DRAWINGS

FIG. 1A is a perspective view of a conventional bag.

FIG. 1B is a sectional view of the conventional bag.

FIG. 2 is a sectional perspective view of a wheel base structure of dolly base wheel bag according to a first preferred embodiment of the present invention.

FIG. 3 is an exploded view of the wheel base structure of dolly base wheel bag according to the above first preferred embodiment of the present invention.

FIG. 4A is a side view of the wheel base structure of dolly base wheel bag according to the above first preferred embodiment of the present invention.

FIG. 4B is a side view of the wheel base structure of dolly base wheel bag according to the above first preferred embodiment of the present invention, illustrating the dolly base wheel bag being carried inclinedly.

FIG. 5 is an exploded perspective view of a wheel base structure of dolly base wheel bag according to a second preferred embodiment of the present invention.

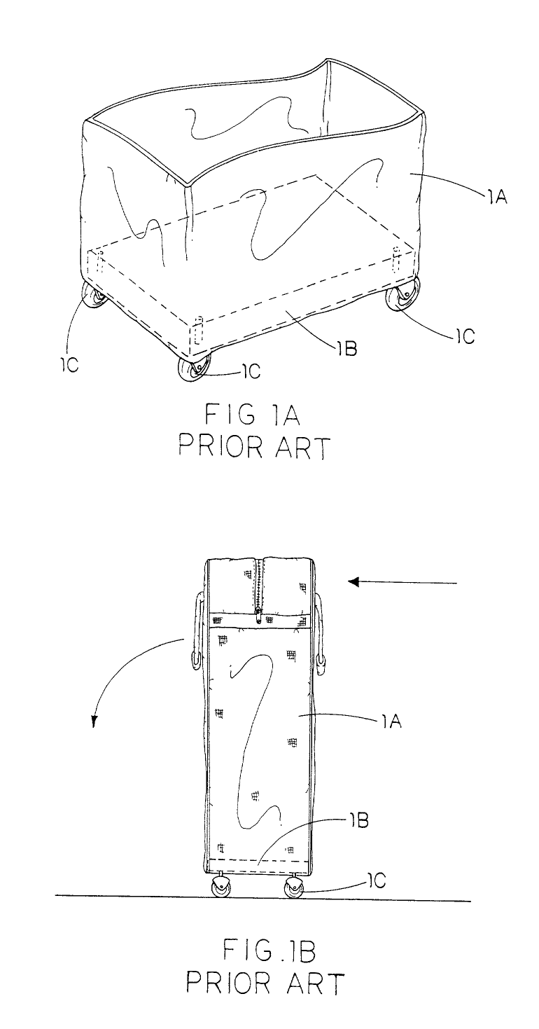

### DETAILED DESCRIPTION OF THE PREFERRED EMBODIMENT

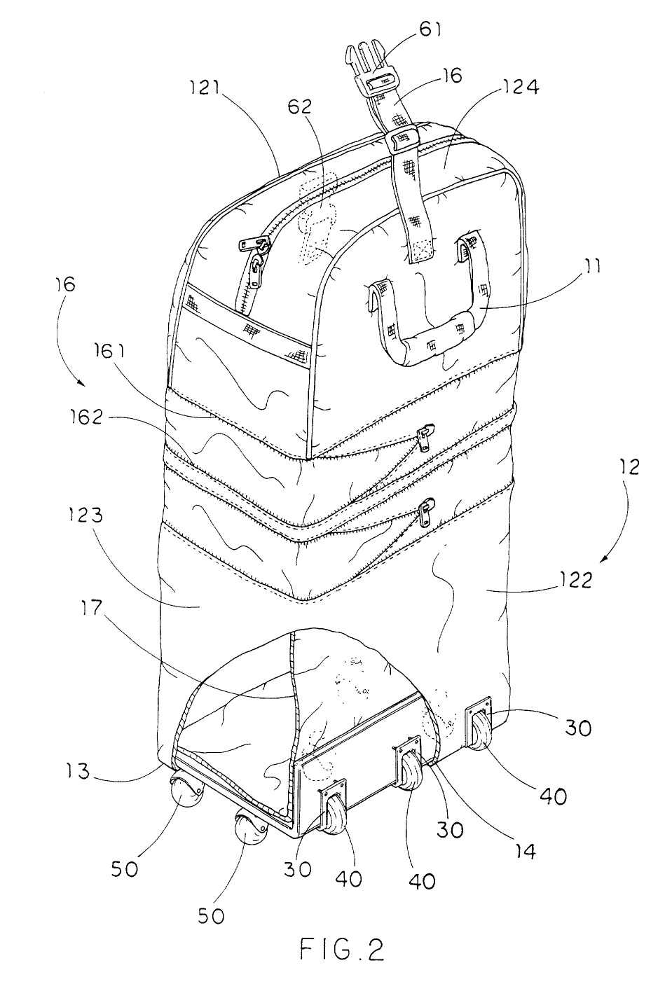

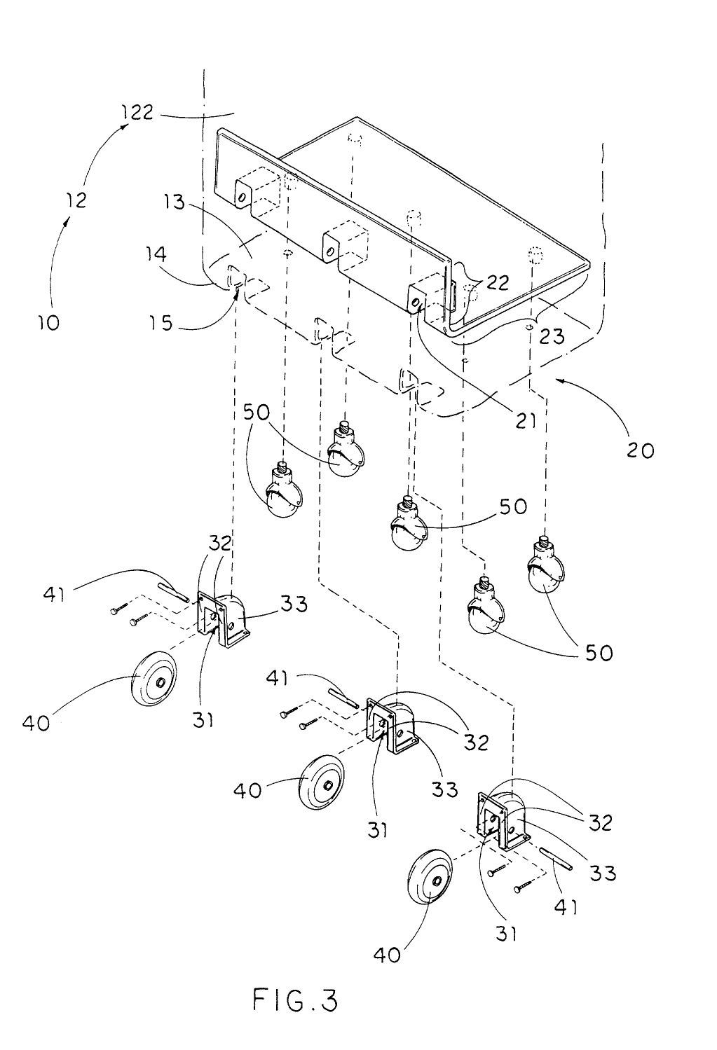

Referring to FIGS. 2 and 3 of the drawings, a wheel base structure of dolly base wheel bag according to a preferred embodiment of the present invention is illustrated. The wheel base structure of dolly base wheel bag comprises a fabric made bag body 10 having a storage compartment 11, an interior surface, an exterior surface, a surrounding sheet 12, a bottom sheet 13, a longitudinal edge 14 defined between the surrounding sheet 12 and the bottom sheet 13, and at least two spaced apart through slots 15 transversely provided at the longitudinal edge 14.

The dolly base wheel bag further comprises reinforcing panel 20 having a L-shaped cross section, which is received in the storage compartment 11, mounted on the interior surface of the bag body 10, wherein the reinforcing panel 20 has at least two parallel mounting slots 21 aligning with the through slots 15 of the bag body 10 respectively, at least two wheel holders 30, each having a wheel cavity 31, substantially attached to the reinforcing panel 20 through the mounting slots 21 at the exterior surface of the bag body 10 respectively, and at least a pair of edge wheels 40 rotatably mounted in the wheel cavities 31 of the wheel holders 30 respectively.

According to the preferred embodiment, the bag body 10 is made of durable fabric material such as nylon or linen that is in relative low cost and has an ability to rough handling. Accordingly, the surrounding sheet 12 having a rectangular shaped comprises a front sheet 121, a back sheet 122 and two side sheets 123, 124 wherein the storage compartment 11 is defined therebetween. The bag body 10 further comprises an inner protective layer 17 mounted on the interior surface of the bag body 10 for covering up the reinforcing panel 20.

As shown in FIG. 2, the bag body 10 can be expanded its size so as to maximize a volume of the storage compartment 11. Accordingly, the bag body 10 further comprises at least an adjusting means 16 for selectively adjusting a volume of the storage compartment 11 of the bag body 10 wherein the adjusting means 16 comprises a first and second attaching members 161, 162 provided on the bag body 10 respectively and arranged to minimize the volume of the storage compartment 11 when the first and second attaching members 161, 162 are attached with each other and to maximize the volume of the storage compartment 11 when the first attaching member 161 is detached from the second attaching member 162.

The first and second attaching members 161, 162 are a first half zipper and a second half zipper attached on the surrounding sheet 12 of the bag body 10 by stitching respectively such that when the first attaching member 161 is engaged with the second attaching member 162, a portion of the surrounding sheet 12 is overlapped to shrink a height of the bag body 10, so as to reduce the volume of the storage compartment 11. In other words, when the first attaching member 161 is disengaged with the second attaching member 162, the surrounding sheet 12 is capable of fully extending to maximize the height thereof, so as to expand the volume of the storage compartment 11.

The reinforcing panel 20, which is made of low cost, durable but lightweight material such as plastic has an upper vertical portion 22 firmly affixed to the surrounding sheet 12 via rivets and a lower horizontal portion 23 firmly affixed to the bottom sheet 13 via rivets wherein each of the mounting slots 21 is extended from the vertical portion 22 to the horizontal portion 23. Accordingly, each mounting slot 21 is an elongated slot vertical formed on the reinforcing panel 20 for communicating the storage compartment 11 of the bag body 10 with an exterior thereof through the respective through slot 15.

Accordingly, the horizontal portion 22 of the reinforcing panel 20 has a size and shape fittedly mounted on the bottom sheet 13 of the bag body 10 so as to reinforce the structure of the dolly bas wheel bag and enhance the bag body's 10 weight supporting ability.

Each of the wheel holders 30 comprises a pair of L-shaped mounting frames 32 firmly mounted on the exterior side of the bag body 10 and encircling the respective mounting slot 21 and a pair of segment-liked supporting walls 33 integrally extended from the mounting frames 32 respectively and arranged to extend into the storage compartment 11 through the mounting slot 21 wherein the wheel cavity 31 is defined between the supporting walls 33.

Each of the edge wheels 40 are rotatably mounted between the supporting walls 33 via a shaft 41 wherein a portion of each edge wheel 40 is outwardly exposed to an exterior of the wheel cavity 31 for supporting the bag body 10 in an inclinedly pulling position. It is worth to mention that the edge wheels 40 should be spaced apart as far as they can, which is the width of the bag body 10, so as to increase the wheel length defined between the two edge wheels 40 at two outermost side of the bag body 10 for stabilization manner.

The dolly base wheel bag further comprises a reinforcing belt 61 having a affixing end firmly affixed on the front sheet 121 of the surrounding sheet 12 and a free end arranged to extend above a top opening of the storage compartment 11, a first connector 62 firmly affixed on the back sheet 122 of the surrounding sheet 12, and a second connector adjustably connected to the free end of the reinforcing belt 61 and detachably connected with the first connector 62.

Accordingly, the first and second connectors 62, 63 are a pair of buckle socket and buckle plug, wherein the free end of the reinforcing belt 61 is adjustably connected with the second connector 63 for selectively adjusting a control length of the reinforcing belt 61 between the front and back sides 121, 122 of the surrounding sheet 12. It is worth to mention that the reinforcing belt 61 can retain the shape of the bag body 10 to prevent the bag body 10 from being burst through the top opening. Moreover, the reinforcing belt 61 can function as a pulling belt to pull the bag body 10 in an inclined manner.

As shown in FIGS. 2 and 3, the dolly base wheel bag further comprises at least a pair of supporting wheels 50 spacedly and rotatably mounted on the bottom sheet 13 of the bag body 10 for substantially supporting the bag body 10 in an upright position wherein in the upright position of the bag body 10, the edge wheels 40 are supported in the suspended manner. Accordingly, each of the supporting wheels 50 has a ball shape rotatably mounted underneath the bag body 10 via a supporting arm 51 rotatably mounted on the bottom sheet 13 thereof, so as to provide a 360 degrees rotational movement of the supporting wheel 50.

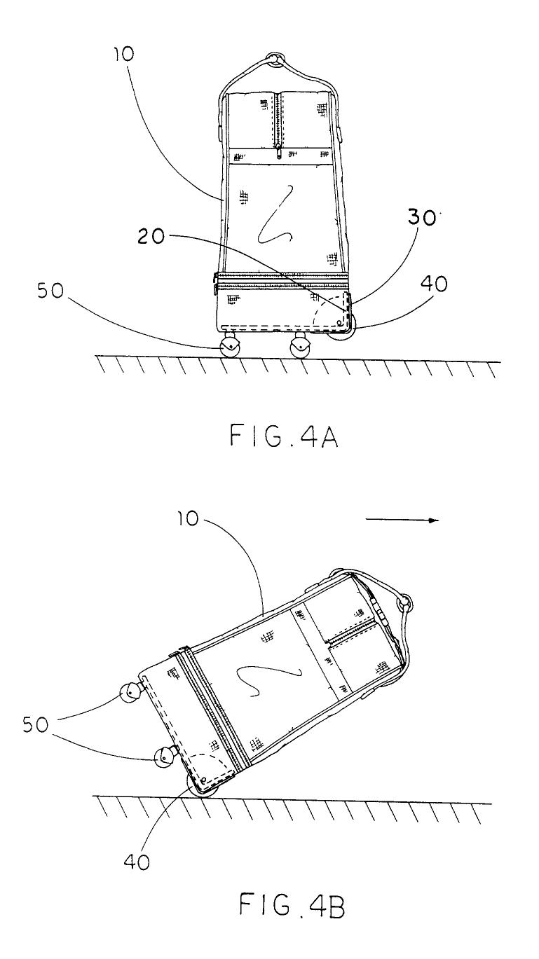

It is worth to mention that when the bag body 10 carries fewer items such as half loaded, the user is able to move the bag body 10 by rotating the supporting wheels 50, as shown in FIG. 4A. However, when the bag body 10 is fully loaded, the user may not able to pull the bag body 10 via the supporting wheels 50.

In order to carry the dolly base wheel bag, a user must intentionally pull the dolly base wheel bag inclinedly so as to lift up the bag body 10, as shown in FIG. 4B. Then, a pulling force can be applied on the bag body 10 via the reinforcing belt 61 for rolling the edge wheels 40 on the ground. Since the dolly base wheel bag is supported in the inclined position, the center of mass of the bag body 10 will be lower for enhancing the stabilization of the dolly base wheel bag, so as to prevent the dolly base wheel bag from being flipped over easily. In other words, the dolly base wheel bag incorporated with the dolly base wheel bag can provide a “stop and go” feature for the user to easily and quickly control the movement of the bag body 10.

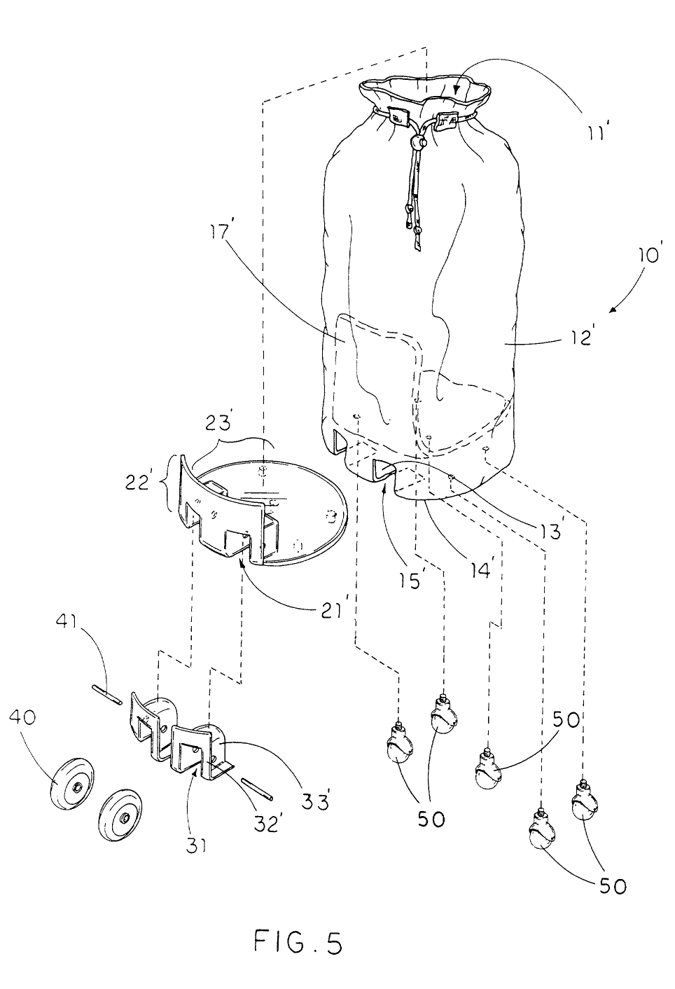

Referring to FIG. 5, a second embodiment of the dolly base wheel bag illustrates an alternative mode of the first embodiment of the present invention, wherein the wheel base structure can be incorporated with any shape of the bag body 10′.

As shown in FIG. 5, the bag body 10′ comprises a surrounding sheet 12′ having a circular cross section and a bottom sheet 13′ to define the storage compartment 11′ therebetween, wherein the longitudinal edge 14′ is defined between the surrounding sheet 12′ and the bottom sheet 13′. The two spaced apart through slots 15′ are transversely provided at the longitudinal edge 14′. The bag body 10′ further comprises an inner protective layer 17′ mounted on the interior surface of the bag body 10′ for covering up the reinforcing panel 20′.

The reinforcing panel 20′ has an upper vertical portion 22′, having an arc-shaped, firmly affixed to the surrounding sheet 12′ via rivets and a lower horizontal portion 23′, having a circular shaped, firmly affixed to the bottom sheet 13′ via rivets wherein each of the mounting slots 21′ is extended from the vertical portion 22′ to the horizontal portion 23′.

Each of the wheel holders 30′ comprises a pair of L-shaped mounting frame 32′ firmly mounted on the exterior surface of the bag body 10′ and encircling the respective mounting slot 21′ and a pair of segment-liked supporting walls 33′ integrally and inwardly extended from two opposed edges of the respective mounting slot 21′ to define the wheel cavity 31′ between the supporting walls 33′.

Each of the edge wheels 40′ are rotatably mounted between the supporting walls 33′ via a shaft 41′ wherein a portion of each edge wheel 40′ is outwardly exposed to the exterior of the wheel cavity 31′ for supporting the bag body 10′ in the inclined pulling position.

The dolly base wheel bag further comprises a reinforcing belt 61′ having a affixing end firmly affixed on the front sheet 121′ of the surrounding sheet 12′ and a free end arranged to extend above a top opening of the storage compartment 11′, a first connector 62′ firmly affixed on the back sheet 122′ of the surrounding sheet 12′, and a second connector adjustably connected to the free end of the reinforcing belt 61′ and detachably connected with the first connector 62′.

The dolly base wheel bag further comprises at least a pair of supporting wheels 50′ spacedly and rotatably mounted on the bottom sheet 13′ of the bag body 10′ for substantially supporting the bag body 10′ in an upright position wherein in the upright position of the bag body 10′, the edge wheels 40′ are supported in the suspended manner.

In view of above, the above disclosure of the wheel base structure of the dolly base wheel bag according to the first and second embodiment of the present invention can substantially achieve the following features:

(a) The dolly base wheel bag can be manufactured in relative low cost because no specific modification is required for the bag body and thus no expensive or complicate part is needed to employ in the present invention. Therefore, the present invention successfully provides an economic and efficient solution for providing reinforced dolly base wheel to carry the bag.

(b) The present invention provide a simple but rigid support for the dolly base wheel bag without altering the original structure of the bag body so as to prolong the service life span while being cost effective.

(c) The user is able to carry the dolly base wheel bag easily and in a stable manner. When the user carries the dolly base wheel bag, the dolly base wheel bag is supported in an inclined manner such that the center of mass of the bag will be lower, so as to prevent the dolly base wheel bag from being flipped over easily.

What is claimed is:

1. A wheel base structure of dolly base wheel bag, comprises:
a fabric made bag body having a storage compartment, an interior surface, an exterior surface, a bottom sheet, a surrounding sheet, a longitudinal edge defined between said bottom sheet and said surrounding sheet, and at least two spaced apart through slots transversely provided at said longitudinal edge;
a reinforcing panel having a L-shaped cross section, which is received in said storage compartment, mounted on said interior surface of said bag body, wherein said reinforcing panel has at least two parallel mounting slots aligning with said through slots of said bag body respectively;
at least two wheel holders, each having a wheel cavity, substantially attached to said reinforcing panel through said mounting slots at said exterior surface of said bag body respectively; and
at least a pair of edge wheels rotatably mounted in said wheel cavities of said wheel holders respectively;
whereby, a user is able to carry said bag body by pulling said bag body in an inclined manner via said edge wheels.

2. A wheel base structure of dolly base wheel bag, as recited in claim 1, wherein said reinforcing panel has an upper vertical portion firmly affixed to said surrounding sheet and a lower horizontal portion firmly affixed to said bottom sheet wherein each of said mounting slots is an elongated slot extended from said vertical portion to said horizontal portion for communicating said storage compartment of said bag body with an exterior thereof through said respective through slot.

3. A wheel base structure of dolly base wheel bag, as recited in claim 1, wherein each of said wheel holders comprises a pair of L-shaped mounting frames firmly mounted on said exterior side of said bag body and encircling said respective mounting slot and a pair of segment-liked supporting walls integrally extended from said mounting frames respectively and arranged to extend into said storage compartment through said mounting slot wherein said wheel cavity is defined between said supporting walls.

4. A wheel base structure of dolly base wheel bag, as recited in claim 2, wherein each of said wheel holders comprises a pair of L-shaped mounting frames firmly mounted on said exterior side of said bag body and encircling said respective mounting slot and a pair of segment-liked supporting walls integrally extended from said mounting frames respectively and arranged to extend into said storage compartment through said mounting slot wherein said wheel cavity is defined between said supporting walls.

5. A wheel base structure of dolly base wheel bag, as recited in claim 3, wherein said bag body further comprises at least an adjusting means for selectively adjusting a volume of said storage compartment of said bag body, wherein said adjusting means comprises a first and second attaching members provided on said bag body respectively and arranged to minimize said volume of said storage compartment when said first and second attaching members are attached with each other and to expand said volume of said storage compartment when said first attaching member is detached from said second attaching member.

6. A wheel base structure of dolly base wheel bag, as recited in claim 4, wherein said bag body further comprises at least an adjusting means for selectively adjusting a volume of said storage compartment of said bag body, wherein said adjusting means comprises a first and second attaching members provided on said bag body respectively and arranged to minimize said volume of said storage compartment when said first and second attaching members are attached with each other and to expand said volume of said storage compartment when said first attaching member is detached from said second attaching member.

7. A wheel base structure of dolly base wheel bag, as recited in claim 5, wherein said first and second attaching members are a first half zipper and a second half zipper attached on said surrounding sheet of said bag body respectively such that when said first attaching member is engaged with said second attaching member, a portion of said surrounding sheet is overlapped to shrink a height of said bag body, so as to reduce said volume of said storage compartment, and when said first attaching member is disengaged with said second attaching member, said surrounding sheet is capable of fully extending to maximize said height thereof, so as to expand said volume of said storage compartment.

8. A wheel base structure of dolly base wheel bag, as recited in claim 6, wherein said first and second attaching members are a first half zipper and a second half zipper attached on said surrounding sheet of said bag body respectively such that when said first attaching member is engaged with said second attaching member, a portion of said surrounding sheet is overlapped to shrink a height of said bag body, so as to reduce said volume of said storage compartment, and when said first attaching member is disengaged with said second attaching member, said surrounding sheet is capable of fully extending to maximize said height thereof, so as to expand said volume of said storage compartment.

9. A wheel base structure of dolly base wheel bag, as recited in claim 4, further comprises at least a pair of supporting wheels spacedly and rotatably mounted on said bottom sheet of said bag body in 360 degree rotatably movable manner for substantially supporting said bag body in an upright position wherein in said upright position of said bag body, said edge wheels are supported in a suspended manner.

10. A wheel base structure of dolly base wheel bag, as recited in claim 6, further comprises at least a pair of supporting wheels spacedly and rotatably mounted on said bottom sheet of said bag body in 360 degree rotatably movable manner for substantially supporting said bag body in an upright position wherein in said upright position of said bag body, said edge wheels are supported in a suspended manner.

11. A wheel base structure of dolly base wheel bag, as recited in claim 8, further comprises at least a pair of supporting wheels spacedly and rotatably mounted on said bottom sheet of said bag body in 360 degree rotatably movable manner for substantially supporting said bag body in an upright position wherein in said upright position of said bag body, said edge wheels are supported in a suspended manner.

12. A wheel base structure of dolly base wheel bag, as recited in claim 8, further comprising a reinforcing belt having a affixing end firmly affixed on one side of said surrounding sheet and a free end arranged to extend above a top opening of said storage compartment, a first connector firmly affixed on an opposite side of said surrounding sheet, and a second connector adjustably connected to said free end of said reinforcing belt and detachably connected with said first connector.

13. A wheel base structure of dolly base wheel bag, as recited in claim 8, further comprising a reinforcing belt having a affixing end firmly affixed on one side of said surrounding sheet and a free end arranged to extend above a top opening of said storage compartment, a first connector firmly affixed on an opposite side of said surrounding sheet, and a second connector adjustably connected to said free end of said reinforcing belt and detachably connected with said first connector.

14. A wheel base structure of dolly base wheel bag, as recited in claim 11, further comprising a reinforcing belt having a affixing end firmly affixed on one side of said surrounding sheet and a free end arranged to extend above a top opening of said storage compartment, a first connector firmly affixed on an opposite side of said surrounding sheet, and a second connector adjustably connected to said free end of said reinforcing belt and detachably connected with said first connector.

15. A wheel base structure of dolly base wheel bag, as recited in claim 11, wherein said surrounding wall, having a rectangular shaped, comprises a front sheet, a back sheet, and two side sheets to define said storage compartment therebetween wherein said vertical portion of said reinforcing panel is firmly attached to said back sheet and said horizontal portion of said reinforcing panel is firmly attached to said bottom sheet of said bag body.

16. A wheel base structure of dolly base wheel bag, as recited in claim 15, wherein said surrounding wall, having a rectangular shaped, comprises a front sheet, a back sheet, and two side sheets to define said storage compartment therebetween wherein said vertical portion of said reinforcing panel is firmly attached to said back sheet and said horizontal portion of said reinforcing panel is firmly attached to said bottom sheet of said bag body.

17. A wheel structure of dolly base wheel bag, as recited 11, wherein said surrounding wall has circular cross section to define said storage compartment wherein said vertical portion of said reinforcing panel, having an arc-shaped is firmly affixed to said surrounding sheet and said horizontal portion of said reinforcing panel, having a circular shaped, is firmly affixed to said bottom sheet.

18. A wheel structure of dolly base wheel bag, as recited 15, wherein said surrounding wall has circular cross section to define said storage compartment wherein said vertical portion of said reinforcing panel, having an arc-shaped is firmly affixed to said surrounding sheet and said horizontal portion of said reinforcing panel, having a circular shaped, is firmly affixed to said bottom sheet.

19. A wheel structure of dolly base wheel bag, as recited in claim 16, wherein said bag body further comprises an inner protective layer mounted on said interior surface of said bag body for covering up said reinforcing panel.

20. A wheel structure of dolly base wheel bag, as recited in claim 18, wherein said bag body further comprises an inner protective layer mounted on said interior surface of said bag body for covering up said reinforcing panel.
